(19) United States
(12) Patent Application Publication
(10) Pub. No.: US 2015/0334136 A1
(43) Pub. Date: Nov. 19, 2015

(54) Method and system for telecommunication network to provide session service to internet

(71) Applicants: Yang Gao, Shenzhen (CN); Lingjiang Mu, Shenzhen, Guangdong (CN)

(72) Inventors: Yang Gao, Shenzhen (CN); Lingjiang Mu, Shenzhen, Guangdong (CN)

(73) Assignee: ZTE Corporation, Shenzhen, Guangdong (CN)

(21) Appl. No.: 14/429,482

(22) PCT Filed: Aug. 30, 2012
(86) PCT No.: PCT/CN2012/080805

§ 371 Date: May 15, 2015

(30) Foreign Application Priority Data
Sep. 29, 2011 (CN) 201110291064.8

(51) Int. Cl. H04L 29/06; H04L 29/12; H04L 29/08

(52) U.S. Cl. CPC H04L 65/1069; H04L 65/1006; H04L 67/02; H04L 65/1033; H04L 61/20

(57) ABSTRACT

Provided is a method for a telecommunication network to provide a session service to the Internet. An access gateway of a telecommunication network supports an Internet application protocol, or an access-side device of the telecommunication network is upgraded to support the Internet application protocol, and the Internet is connected to the telecommunication network via the access gateway or the upgraded access-side device. The method further includes that an Internet user establishes a session with a telecommunication user or another Internet user via a telecommunication network. A system for a telecommunication network to provide a session service to the Internet is also provided. By upgrading an access-side device of a telecommunication network, the disclosure enables the access-side device to support an Internet application protocol and converges the Internet with the telecommunication network, thus being able to provide a session service to an Internet user. The disclosure facilitates the usage of the session service by the Internet user.

### TECHNICAL FIELD

The disclosure relates to a technology of converging a telecommunication network with the Internet, and in particular to a method and system for a telecommunication network to provide a session service to the Internet.

### BACKGROUND

An Internet Protocol (IP) Multimedia Subsystem (IMS) is a development direction of future multimedia communication, and is also the most important part of a Next Generation Network (NGN). The IMS is a subsystem supporting an IP multimedia service and proposed by the Third Generation Partnership Project (3GPP), and a remarkable feature of the IMS is that a Session Initiation Protocol (SIP) system is adopted and communication is independent of an access way. The IMS may have multiple capacities, such as the capacity of separating multiple multimedia service control functions from a bearing capacity, the capacity of separating a call from a session, the capacity of separating an application from a service, the capacity of separating a service from a network, and the capacity of converging a mobile network with the Internet, and etc.

The IMS provides a new multimedia service form, provides more services for users, and opens up a new income source for operators. Multimedia services of the IMS include Voice over Internet Protocol (VoIP), Presence, Push-to-Talk over Cellular (PoC), InstantMessage, VideoSharing, content sharing, RichCall and the like. In addition, under an enterprise's fixed environment, the IMS can also provide a service similar to existing fixed switching service, for example, the IMS can provide an enterprise switchboard service by an IPCentrex server to implement short number interconnection within the enterprise. By an IPConference server, the IMS can provide a conference call service to enable a cell phone, a Personal Computer (PC) and a traditional telephone to be connected to the same system, so as to implement a conference call.

In the current industry background, firstly mobile operators, fixed operators, and mobile/fixed mixture operators are possible to converge with one another in roles. That is, a mobile operator may become a mobile/fixed mixture operator, and a fixed operator may obtain a mobile operating license, and so on. Therefore, all telecommunication operators urgently need a technology to converge a mobile network with a fixed network together. And the IMS exactly has such a characteristic. The IMS is independent of a specific bearing type, and may provide an arbitrary IP channel with a consecutive service of IMS traffic, from voice to multimedia data etc.. The IMS also has an interworking capability with a traditional network, which enables an IMS terminal to interwork with a traditional mobile terminal and a traditional fixed terminal.

A converged network will bring users new service experience. No matter what access networks and terminal devices are, users can obtain the same voice and multimedia services in the same way. As such, the compatibility of mobility and individuation is achieved.

Nowadays, many famous Internet service providers have achieved great success by providing user-to-user communication services, such as MSN, QQ and Skype etc. The provided services mainly include VoIP, instant messaging, and video chat etc. Obviously, these applications have a great impact on existing telecommunication operators' voice and information services. However, at the same time, if these Internet applications are transplanted to a mobile terminal, it is also a new business opportunity for telecommunication operators. And the IMS can provide such technical means. The IMS can provide services, such as VoIP, instant messaging and video chat etc., which may either replace or interwork with the above Internet services. Therefore, in the face of Internet service providers, telecommunication operators may have multiple solutions because of the existence of IMS, such as creating their own brands, competing with the Internet, and implementing the interworking cooperation or choosing competition together with cooperation.

Currently, the Internet is a general trend of information communication, and Internet applications of the Internet have the integration characteristic. For example, social applications like Facebook and Google+, integrate a variety of functions, such as IM, Web2.0, Blog, audio and video chat, and audio and video conference etc., and a telecommunication network (e.g. the IMS) can also provide similar services. The telecommunication network should open session services to the Internet applications so as to provide users with a broader range of services.

### SUMMARY

In view of this, the main purpose of the disclosure is to provide a method and system for a telecommunication network to provide a session service to the Internet to enable the telecommunication network to provide the session service to a user.

To realize the purpose above, the technical solutions of the disclosure are implemented as follows.

A method for a telecommunication network to provide a session service to the Internet, wherein the telecommunication network supports an Internet application protocol and the Internet is connected to the telecommunication network, and the method may further include:

an Internet user establishes a session with a telecommunication user or another

Internet user through the telecommunication network.

Preferably, the method may further include:

the telecommunication network is connected to the Internet through an access gateway supporting an Internet protocol;

or the telecommunication network is connected to the Internet through enabling an access-side device to support an Internet protocol.

Preferably, the Internet protocol may include Hypertext Transfer Protocol (HTTP), or HTTP over Security Socket Layer (HTTPS), or Representational State Transfer (REST), or SIP Over HTTP or WebSocket.

Preferably, the access gateway or the upgraded access-side device may realize conversion between HTTP and SIP.

Preferably, the method may further include:

the telecommunication network allocates a number or an identifier to the Internet user, wherein the allocated number or identifier is different from a user name in the Internet;

or a user name in an Internet application is taken as the number or the identifier of the telecommunication network;

the Internet user registers with the telecommunication network and initiates a session request using the allocated number or identifier or the user name in the Internet application, and/or the Internet user accepts a session request, so as to establish the session with the telecommunication user or the another Internet user.

Preferably, the method may further include:

a number or an identifier of the telecommunication network is associated with a user name in an Internet function;

the telecommunication network calls an Internet user terminal or a telecommunication terminal preferentially through service control, or makes a forking call directed to the Internet user terminal and the telecommunication terminal.

Preferably, the access-side device may be a Session Border Controller (SBC) and a Proxy Call Session Control Function entity (P-CSCF);

the Internet application protocol may be the HTTP/Simple Object Access protocol (SOAP)/Web2.0/HyperText Markup Language 5 (HTML5) protocol.

Preferably, the operation that the Internet user registers with the telecommunication network using the allocated number or identifier may include:

the Internet user initiates a registration request by using the HTTP/SOAP/Web2.0/HTML5 protocol;

the SBC forwards the registration request to the P-CSCF by using the HTTP/SOAP/Web2.0/HTML5 protocol;

the P-CSCF encapsulates the registration request as an SIP message, and forwards the SIP message to a Serving Call Session Control Function entity (S-CSCF);

the S-CSCF completes the registration of the Internet user, and returns a registration success message.

Preferably, the operation that the Internet user initiates a session request using the allocated number or identifier may include:

the Internet user initiates a session request by using the HTTP/SOAP/Web2.0/HTML5 protocol;

the SBC forwards the session request to the P-CSCF by using the HTTP/SOAP/Web2.0/HTML5 protocol;

the P-CSCF encapsulates the session request as an SIP message, and forwards the SIP message to an S-CSCF;

the S-CSCF calls a called party and returns a call success message.

Preferably, the operation that the Internet user receives a session request may include:

after an S-CSCF receives a call request directed to the Internet user, the S-CSCF forwards the call request to the P-CSCF corresponding to the Internet user;

the P-CSCF converts the call request in the format of INVITE into a call message under the HTTP/SOAP/Web2.0/HTML5 protocol;

the SBC transparently transmits the call message under the HTTP/SOAP/Web2.0/HTML5 protocol to the Internet user;

the Internet user responds to the call message so as to establish a session with a caller.

A system for a telecommunication network to provide a session service to the Internet is provided, wherein an access-side device of the telecommunication network supports an Internet application protocol, and the Internet is connected to the telecommunication network via an access gateway or an upgraded access-side device, wherein the telecommunication network is configured to provide a session service to an Internet user, and establish a session between the Internet user and a telecommunication user or another Internet user.

Preferably, the Internet user establishes the session with the telecommunication user or the another Internet user through a Real-Time Communication in WEB-browsers (RTCWeb) technology, an SIP Plugin, or HTTP/SOAP/Web2.0/HTML5.

Preferably, the telecommunication network is connected to the Internet through an access gateway supporting an Internet protocol;

or the telecommunication network is connected to the Internet through enabling an access-side device to support an Internet protocol;

the Internet protocol includes HTTP, or HTTPS, or REST, or SIP Over HTTP or WebSocket;

the access gateway or the upgraded access-side device realizes conversion between HTTP and SIP.

Preferably, the telecommunication network is further configured to allocate a number or an identifier to the Internet user, wherein the allocated number or identifier is different from a user name in the Internet; or configured to take a user name in an Internet application as the number or the identifier of the telecommunication network;

the Internet user registers with the telecommunication network and initiates a session request using the allocated number or identifier or the user name in the Internet application, and/or the Internet user accepts a session request, so as to establish the session with the telecommunication user or the another Internet user.

Preferably, the telecommunication network associates a number or an identifier of the telecommunication network with a user name in an Internet function;

the telecommunication network calls an Internet user terminal or a telecommunication terminal preferentially through service control, or makes a forking call directed to Internet user terminal and the telecommunication terminal.

Preferably, the access-side device may be an SBC and a P-CSCF;

the Internet application protocol may be the HTTP/SOAP/Web2.0/HTML5 protocol.

By upgrading an access-side device of a telecommunication network, the disclosure enables the access-side device to support an Internet application protocol and converges the Internet with the telecommunication network, thus being able to provide a session service to an Internet user. The disclosure facilitates the usage of the session service by the Internet user.

### BRIEF DESCRIPTION OF THE DRAWINGS

FIG. 1 shows an architecture diagram of an Internet user acting as a caller according to an embodiment of the disclosure;

FIG. 2 shows an architecture diagram of an Internet user acting as a called party (callee) according to an embodiment of the disclosure;

FIG. 3 shows an architecture diagram of a conference in which an Internet user participates according to an embodiment of the disclosure;

FIG. 4 shows an architecture diagram of an Internet user accessing a telecommunication network according to an embodiment of the disclosure;

FIG. 5 shows another architecture diagram of an Internet user accessing a telecommunication network according to an embodiment of the disclosure;

FIG. 6 shows a flowchart of Internet user registration according to an embodiment of the disclosure;

FIG. 7 shows a flowchart of an Internet user making a call through a telecommunication network according to an embodiment of the disclosure;

FIG. 8 shows a flowchart of an Internet user being called according to an embodiment of the disclosure;

FIG. 9 shows a flowchart of a telecommunication network dispatching a new number for an Internet user according to an embodiment of the disclosure;

FIG. 10 shows another flowchart of a telecommunication network dispatching a new number for an Internet user according to an embodiment of the disclosure;

FIG. 11 is a flowchart of registering a user name in an Internet application according to an embodiment of the disclosure;

FIG. 12 shows a flowchart of calling a user name in an Internet application according to an embodiment of the disclosure;

FIG. 13 shows a flowchart of preferentially using an Internet session client according to an embodiment of the disclosure;

FIG. 14 shows a flowchart of preferentially using a telecommunication terminal according to an embodiment of the disclosure; and

FIG. 15 shows a flowchart of making a forking call directed to an Internet session client and a telecommunication terminal according to an embodiment of the disclosure.

### DETAILED DESCRIPTION

The basic idea of the disclosure is that an access-side device of a telecommunication network is upgraded to enable the access-side device to support an Internet application protocol, and thus the Internet and the telecommunication network are converged, thereby providing a session service to an Internet user.

In the disclosure, the telecommunication network includes, but is not limited to an IMS, an NGN, and a softswitch and etc.

The session service includes, but is not limited to audio calls, video calls, various value-added telecommunication services, various supplementary telecommunication services, audio conferences, video conferences, Instance Messaging (IM), whiteboard applications, file transmission, and remote control etc.

In a system for a telecommunication network to provide a session service to the Internet of the disclosure, an access-side device of the telecommunication network supports an Internet application protocol, and the Internet is connected to the telecommunication network via an access gateway or the upgraded access-side device, wherein

the telecommunication network is configured to provide a session service to an Internet user, and establish a session between the Internet user and a telecommunication user or another Internet user.

The telecommunication network realizes the connection with the Internet through an access gateway supporting an Internet protocol;

or the telecommunication network realizes the connection with the Internet through enabling an access-side device to support an Internet protocol.

The Internet protocol includes HTTP, or HTTPS, or REST, or SIP Over HTTP or WebSocket, wherein the access gateway or the upgraded access-side device realizes conversion between HTTP and SIP.

The Internet user establishes the session with the telecommunication user or another Internet user through a Real-Time Communication in WEB-browsers (RTCWeb) technology, an SIP Plugin, or HTTP/SOAP/Web2.0/HTML5.

The telecommunication network is further configured to allocate a number or an identifier to the Internet user, wherein the allocated number or identifier is different from a user name in the Internet; or configured to take a user name in an Internet application as the number or the identifier of the telecommunication network;

the Internet user registers with the telecommunication network and initiates a session request using the allocated number or identifier or the user name in the Internet application, and/or the Internet user accepts a session request, so as to establish the session with the telecommunication user or another Internet user.

The telecommunication network associates a number or an identifier of the telecommunication network with a user name in an Internet function;

the telecommunication network calls an Internet user terminal or a telecommunication terminal preferentially through service control, or makes a forking call directed to the Internet user terminal and the telecommunication terminal.

The access-side device is an SBC and a P-CSCF.

The Internet application protocol is the HTTP/SOAP/Web2.0/HTML5 protocol.

The operation that the Internet user registers with the telecommunication network using the allocated number or identifier includes:

the Internet user initiates a registration request by using the HTTP/SOAP/Web2.0/HTML5 protocol;

the SBC forwards the registration request to the P-CSCF by using the HTTP/SOAP/Web2.0/HTML5 protocol;

the P-CSCF encapsulates the registration request as an SIP message, and forwards the SIP message to a Serving Call Session Control Function entity (S-CSCF);

the S-CSCF completes the registration of the Internet user, and returns a registration success message.

The operation that the Internet user initiates a session request using the allocated number or identifier includes:

the Internet user initiates a session request by using the HTTP/SOAP/Web2.0/HTML5 protocol;

the SBC forwards the session request to the P-CSCF by using the HTTP/SOAP/Web2.0/HTML5 protocol;

the P-CSCF encapsulates the session request as an SIP message, and forwards the SIP message to an S-CSCF;

the S-CSCF calls a called party and returns a call success message.

The operation that the Internet user receives a session request includes:

after an S-CSCF receives a call request directed to the Internet user, the S-CSCF forwards the call request to the P-CSCF corresponding to the Internet user;

the P-CSCF converts the call request in the format of INVITE into a call message under the HTTP/SOAP/Web2.0/HTML5 protocol;

the SBC transparently transmits the call message under the HTTP/SOAP/Web2.0/HTML5 protocol to the Internet user;

the Internet user responds to the call message so as to establish a session with a caller.

Related network elements in the system for a telecommunication network to provide a session service to the Internet of the disclosure are further described in details below in combination with the accompanying drawings.

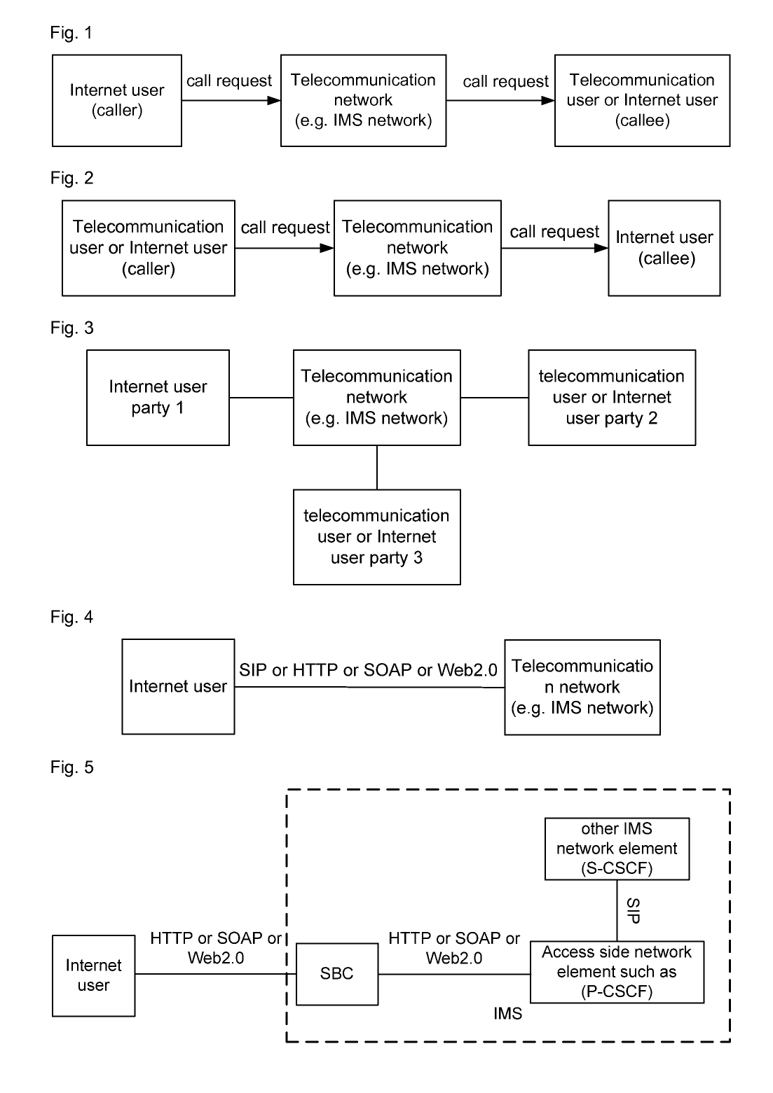

FIG. 1 shows an architecture diagram of an Internet user acting as a caller according to an embodiment of the disclosure. As illustrated in FIG. 1, the Internet user uses a session service provided by a telecommunication network, acts as a caller and establishes a session with a called party. The called party may be a telecommunication user or another Internet user.

FIG. 2 shows an architecture diagram of an Internet user acting as a called party according to an embodiment of the disclosure. As illustrated in FIG. 2, the Internet user uses a session service provided by a telecommunication network, acts as a called party, and may receive a call request from a caller and establish a session. The caller may be a telecommunication user or another Internet user.

FIG. 3 shows an architecture diagram of a conference in which an Internet user participates according to an embodiment of the disclosure. As illustrated in FIG. 3, the Internet user uses a session service provided by a telecommunication network, acts as a participant of a conference, and implements an audio/video/whiteboard conference. The conference initiator (the conference chairman) may be a telecommunication user or an Internet user. The Internet user may initiate the conference or may be invited to attend the conference.

FIG. 4 shows an architecture diagram of an Internet user accessing a telecommunication network according to an embodiment of the disclosure. As illustrated in FIG. 4, an Internet session client, as a part of an Internet application, may use the following technologies to implement registration, initiate a session request and accept a session request:

the RTCWeb technology is employed to implement registration, initiate a session request and accept a session request; or

a plug-in of a Web Browser is employed to provide an SIP function, so as to initiate SIP registration, initiate a session request and accept a session request; or

a protocol such as an HTTP/SOAP/Web2.0 protocol is employed to implement registration, initiate a session request and accept a session request; or a plug-in of the HTTP/SOAP/Web2.0 or standardized HTML5 may be employed.

The Internet session client may be implemented based on software or a Web Browser, or may be downloaded from a server to a browser.

The Internet user may access the telecommunication network using protocols including SIP, HTTP, SOAP, and Web2.0 etc.

FIG. 5 shows another architecture diagram of an Internet user accessing a telecommunication network according to an embodiment of the disclosure. As illustrated in FIG. 5, for the Internet user accessing the telecommunication network using protocols except the SIP protocol, an enhanced requirement is needed for the telecommunication network. The specific requirement is that for a related network element accessing the telecommunication network, an access-side device of the telecommunication network needs to support a related protocol. For example, when an Internet user accesses an IMS using protocols such as the HTTP, SOAP, or Web2.0 protocol etc., an access-side device of the IMS, such as a network element like an SBC and a P-CSCF etc., needs to support protocols such as SIP, HTTP, SOAP, or Web2.0 etc. The IMS access device (such as a P-CSCF) provides conversion mapping between protocols such as HTTP, SOAP, or Web2.0 etc. and an SIP protocol (a flow, registration, and call are needed in the embodiment).

In the disclosure, a new number is dispatched to an Internet user in a telecommunication network (e.g. an IMS), and the number or identifier (e.g. a Public Switched Telephone Network (PSTN), a Mobile Station International Subscriber Directory Number (MSISDN), a Telephone Uniform Resource Identifier (Tel URI) and an SIP URI etc.) is different from a user name (e.g. an account of Fackbook or Taobao etc.) of the Internet user in an original Internet function. There is no special requirement for user management of the telecommunication network (e.g. the IMS), but an Internet function needs to associate a telecommunication network number (or identifier) with an Internet function account.

Alternatively, a user name (e.g. an account of Fackbook or Taobao etc.) of an Internet user in an Internet application is used to register with and make a call in an IMS. That is, the IMS supports the user name (which may have a non SIP URI or Tel URI format) in the Internet application.

Alternatively, an existing number or identifier (e.g. a PSTN, an MSISDN, a Tel URI and an SIP URI etc.) of a telecommunication network is allowed to be associated with a user name (e.g. an account of Fackbook or Taobao etc.) in an Internet function. The telecommunication network may transmit a call to the Internet or a telecommunication terminal preferentially by service control (e.g. a Multimedia Telephony Application Server (MMTel AS) of an IMS), and provide a supplementary service function such as call forwarding on no reply, or a forking call (the mechanism of Forking). The telecommunication network number (or identifier) is associated with the account of the Internet function by the Internet function.

Specific applications of the convergence of the Internet with the telecommunication network are described in details below.

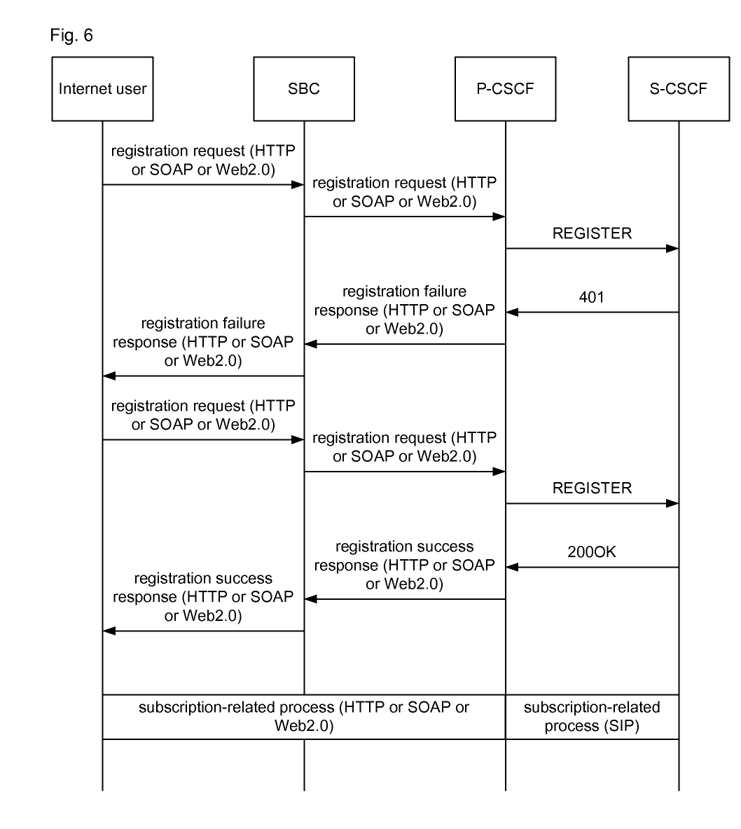

FIG. 6 shows a flowchart of Internet user registration according to an embodiment of the disclosure. As illustrated in FIG. 6, the flow of the Internet user registration in the embodiment includes the following steps:

1) an Internet user initiates a registration request using the HTTP or SOAP or Web2.0 protocol;

2) an SBC forwards the registration request using the HTTP or SOAP or Web2.0 protocol;

3) a P-CSCF converts a registration message under the HTTP or SOAP or Web2.0 protocol into SIP REGISTER;

4) an S-CSCF returns 401, with security challenge;

5) the P-CSCF converts 401 into a registration failure response under the HTTP or SOAP or Web2.0 protocol;

6) the SBC forwards the registration failure response under the HTTP or SOAP or Web2.0 protocol;

7) the Internet user re-initiates a registration request, using the HTTP or SOAP or Web2.0 protocol, carrying authentication about the security challenge;

8) the SBC forwards the registration request, using the HTTP or SOAP or Web2.0 protocol;

9) the P-CSCF converts a registration message under the HTTP or SOAP or Web2.0 protocol into SIP REGISTER;

10) the S-CSCF returns 2000K;

11) the P-CSCF converts 2000K into a registration success response under the HTTP or SOAP or Web2.0 protocol;

12) the SBC forwards the registration success response under the HTTP or SOAP or Web2.0 protocol;

13) the Internet user initiates a subscription (HTTP or SOAP or Web2.0 protocol) process; and

14) the P-CSCF is converted for SIP subscription.

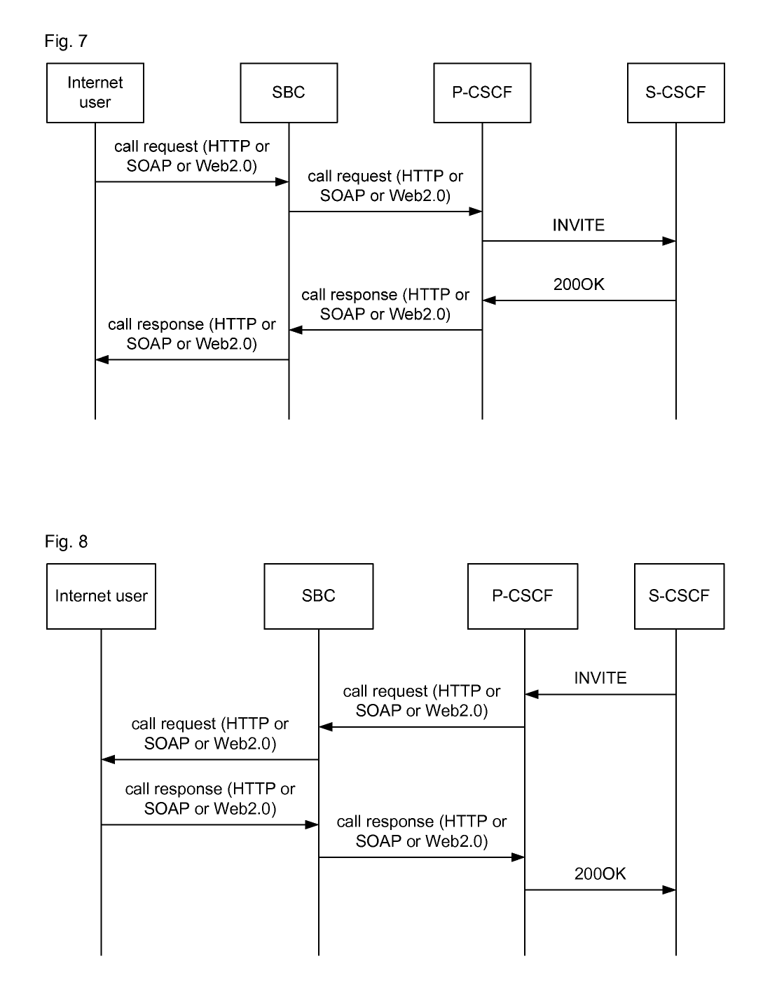

FIG. 7 shows a flowchart of an Internet user making a call through a telecommunication network according to an embodiment of the disclosure. As illustrated in FIG. 7, the flow of the Internet user making a call through the telecommunication network in the embodiment includes the following steps:

1) the Internet user initiates a call request, using the HTTP or SOAP or Web2.0 protocol;

2) an SBC forwards the call request, using the HTTP or SOAP or Web2.0 protocol;

3) a P-CSCF converts a call message under the HTTP or SOAP or Web2.0 protocol into SIP INVITE;

4) an S-CSCF returns 2000K;

5) the P-CSCF converts 2000K into a call success response under the HTTP or SOAP or Web2.0 protocol; and

6) the SBC forwards the call success response under the HTTP or SOAP or Web2.0 protocol.

FIG. 8 shows a flowchart of an Internet user being called according to an embodiment of the disclosure. As illustrated in FIG. 8, the flow of the Internet user acting as a called party in the embodiment includes the following steps:

1) the Internet user accepts a call request, and an S-CSCF sends INVITE to a P-CSCF corresponding to the Internet user;

2) a P-CSCF converts INVITE into a call message under the HTTP or SOAP or Web2.0 protocol;

3) an SBC transparently transmits the call message under the HTTP or SOAP or Web2.0 protocol;

4) the Internet user returns 2000K;

5) the SBC transparently transmits a call success response message under the HTTP or SOAP or Web2.0 protocol; and

6) the P-CSCF converts the call success response message under the HTTP or SOAP or Web2.0 protocol into 2000K.

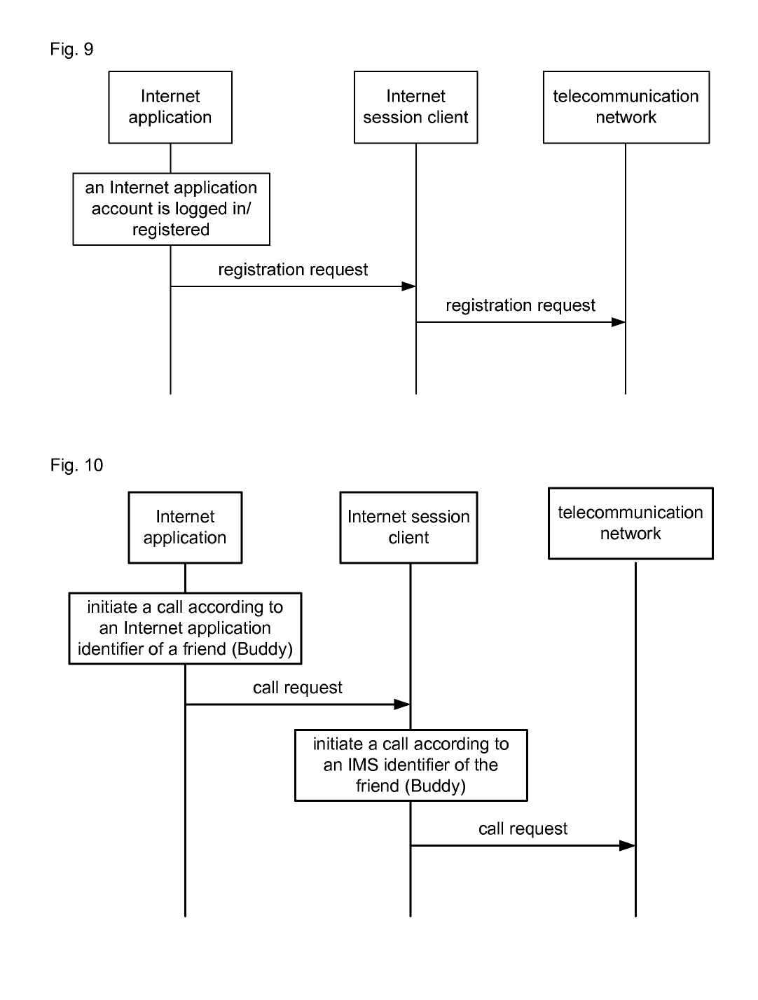

FIG. 9 shows a flowchart of the telecommunication network dispatching a new number for an Internet user according to an embodiment of the disclosure. As illustrated in FIG. 9, dispatching a new number for an Internet user by the telecommunication network in the embodiment includes:

1) an Internet application account is logged in/registered;

2) an Internet session client is triggered to initiate a registration request to the telecommunication network; and

3) the Internet session client initiates a registration request to the telecommunication network using a telecommunication network identifier.

FIG. 10 shows another flowchart of a telecommunication network dispatching a new number for an Internet user according to an embodiment of the disclosure. As illustrated in FIG. 10, dispatching a new number for an Internet user by the telecommunication network in the embodiment includes:

1) an Internet application initiates a call according to an Internet application identifier of a friend (Buddy), for example, Facebook or Taobao initiates a call according to an identifier of a friend;

2) an Internet session client is triggered to initiate a call request to the telecommunication network; and

3) the Internet session client initiates a call request according to an IMS identifier of the friend (Buddy).

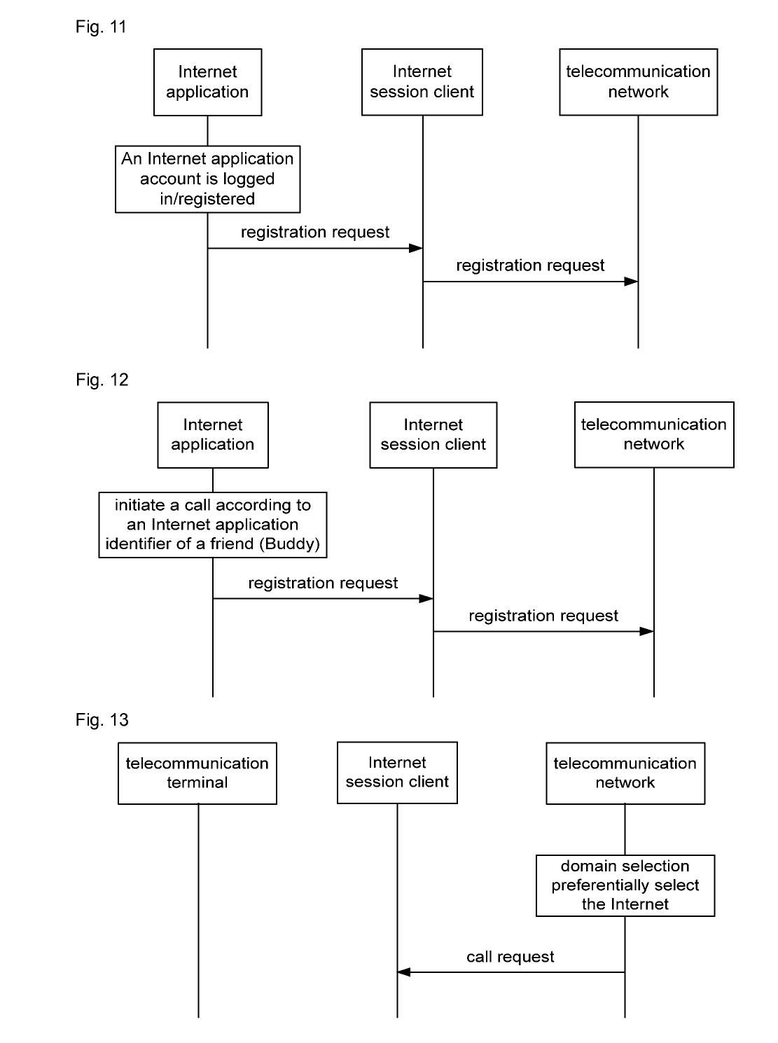

FIG. 11 shows a flowchart of user name registration in an Internet application according to an embodiment of the disclosure. As illustrated in FIG. 11, the flow of registering a user name in the Internet application in the embodiment includes:

1) an Internet application account is logged in/registered;

2) an Internet session client is triggered to initiate a registration request to a telecommunication network; and

3) the Internet session client initiates a registration request to the telecommunication network using an Internet application identifier; at the moment, the telecommunication network is required to support the Internet application identifier, such as number dispatching, registration, authentication and management and etc.

FIG. 12 shows a flowchart of calling a user name in an Internet application according to an embodiment of the disclosure. As illustrated in FIG. 12, the flow of calling a user name in an Internet application in the embodiment includes:

1) an Internet application initiates a call according to an Internet application identifier of a friend (Buddy), for example, Facebook or Taobao initiates a call according to an identifier of a friend;

2) an Internet session client is triggered to initiate a call request to a telecommunication network; and

3) the Internet session client initiates a call request according to the Internet application identifier of the friend (Buddy).

In the embodiment, the flow of registering or initiating a call using an existing number or identifier of the telecommunication network is the same as that of dispatching a new number for an Internet user in the telecommunication network (such as an IMS).

FIG. 13 shows a flowchart of preferentially using an Internet session client according to an embodiment of the disclosure. As illustrated in FIG. 13, the flow of preferentially using an Internet session client in the embodiment includes:

1) both a telecommunication terminal and an Internet session client may register with a telecommunication network; the user identifier receives a call, and the Internet is preferentially selected by the telecommunication network according to a domain selection strategy. Preferably, the domain selection may be combined with a registration state, for example, if the Internet session client is not registered or is busy, the call is sent to the telecommunication terminal; or, the Internet session client does not respond, the call is sent to the telecommunication terminal;

2) the telecommunication network routes the call to the Internet session client.

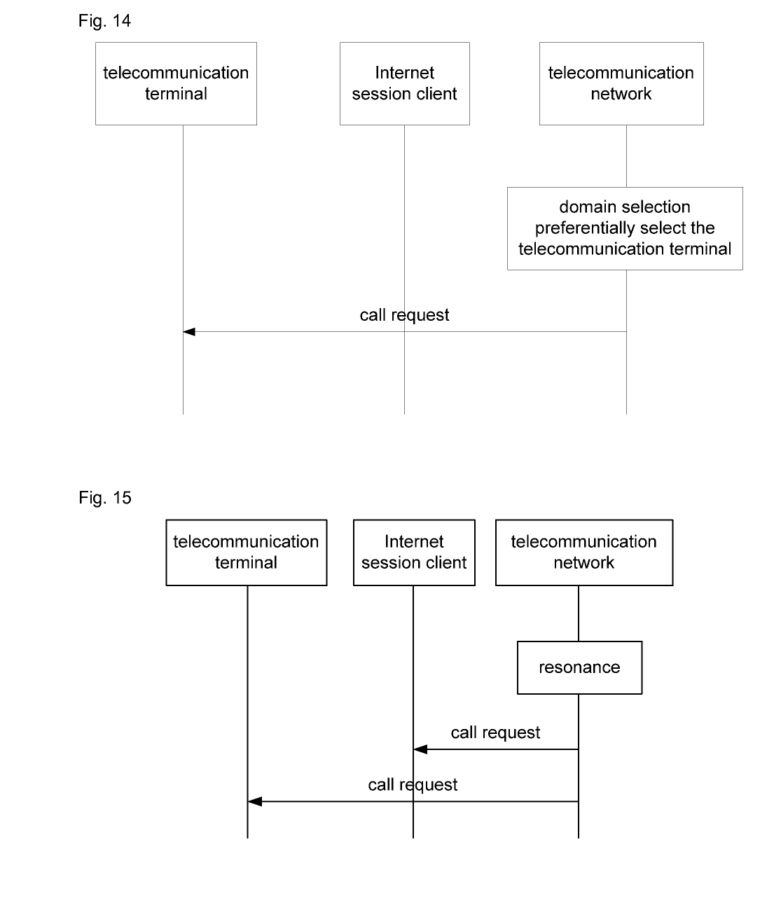

FIG. 14 shows a flowchart of preferentially using a telecommunication terminal according to an embodiment of the disclosure. As illustrated in FIG. 14, the flow of preferentially using a telecommunication terminal in the embodiment includes:

1) both a telecommunication terminal and an Internet session client may register with a telecommunication network; the user identifier receives a call, and the telecommunication terminal is preferentially selected by the telecommunication network according to a domain selection strategy; further, the domain selection may be combined with the registration state, for example, if the telecommunication terminal is not registered or is busy, the call is sent to the Internet session client; or, the telecommunication terminal does not respond, the call is sent to the Internet session client; and

2) the telecommunication network routes the call to the telecommunication terminal.

FIG. 15 shows a flowchart of making a forking call directed to an Internet session client and a telecommunication terminal according to an embodiment of the disclosure.

As illustrated in FIG. 15, the flow of making a forking call directed to an Internet session client and a telecommunication terminal in the embodiment includes:

1) both a telecommunication terminal and an Internet session client may register with a telecommunication network; the user identifier receives a call, and the telecommunication network initiates resonance to simultaneously call the telecommunication terminal and the Internet session client; the technologies used in resonance may include Forking, a forking call initiated by an AS, and the like;

2) the telecommunication network routes the call to the telecommunication terminal and the Internet session client.

The above are merely preferred embodiments of the disclosure, but are not intended to limit the protection scope of the disclosure.

What is claimed is:

1. A method for a telecommunication network to provide a session service to Internet, wherein the telecommunication network supports an Internet application protocol and the Internet is connected to the telecommunication network; the method further comprising:
establishing, by an Internet user, a session with a telecommunication user or another Internet user through the telecommunication network.

2. The method according to claim 1, further comprising:
connecting, by the telecommunication network, to the Internet through an access gateway supporting an Internet protocol; or
connecting, by the telecommunication network, to the Internet through enabling an access-side device to support an Internet protocol.

3. The method according to claim 2, wherein the Internet protocol comprises Hypertext Transfer Protocol (HTTP), or HTTP over Security Socket Layer (HTTPS), or Representational State Transfer (REST), or Session Initiation Protocol (SIP) Over HTTP or WebSocket.

4. The method according to claim 3, wherein the access gateway realizes or the access-side device is upgraded to realize conversion between HTTP and SIP.

5. The method according to claim 1, further comprising:
allocating, by the telecommunication network, a number or an identifier to the Internet user, wherein the allocated number or identifier is different from a user name in the Internet;
or taking a user name in an Internet application as the number or the identifier of the telecommunication network;
registering, by the Internet user, with the telecommunication network and initiating a session request using the allocated number or identifier or the user name in the Internet application, and/or accepting, by the Internet user, a session request to establish the session with the telecommunication user or the another Internet user.

6. The method according to claim 1, further comprising:
associating a number or an identifier of the telecommunication network with a user name in an Internet function;
calling, by the telecommunication network, an Internet user terminal or a telecommunication terminal preferentially through service control, or making a forking call directed to the Internet user terminal and the telecommunication terminal.

7. The method according to claim 1, wherein the access-side device is a Session Border Controller (SBC) and a Proxy Call Session Control Function entity (P-CSCF);
the Internet application protocol is HTTP/Simple Object Access protocol (SOAP)/Web2.0/HyperText Markup Language 5 (HTML5).

8. The method according to claim 7, wherein registering, by the Internet user, with the telecommunication network using the allocated number or identifier comprises:
initiating, by the Internet user, a registration request by using the HTTP/SOAP/Web2.0/HTML5;
forwarding, by the SBC, the registration request to the P-CSCF by using the HTTP/SOAP/Web2.0/HTML5;
encapsulating, by the P-CSCF, the registration request as an SIP message, and forwarding the SIP message to a Serving Call Session Control Function entity (S-CSCF);
completing, by the S-CSCF, the registration of the Internet user, and returning a registration success message.

9. The method according to claim 7, wherein initiating, by the Internet user, a session request using the allocated number or identifier comprises:
initiating, by the Internet user, a session request by using the HTTP/SOAP/Web2.0/HTML5;
forwarding, by the SBC, the session request to the P-CSCF by using the HTTP/SOAP/Web2.0/HTML5;
encapsulating, by the P-CSCF, the session request as an SIP message, and forwarding the SIP message to an S-CSCF;
calling, by the S-CSCF, a called party, and returning a call success message.

10. The method according to claim 7, wherein accepting, by the Internet user, a session request comprises:
after an S-CSCF receives a call request directed to the Internet user, forwarding, by the S-CSCF, the call request to the P-CSCF corresponding to the Internet user;
converting, by the P-CSCF, the call request in an INVITE format into a call message under the HTTP/SOAP/Web2.0/HTML5;
transparently transmitting, by the SBC, the call message under the HTTP/SOAP/Web2.0/HTML5 to the Internet user; and
responding to the call message by the Internet user so as to establish a session with a caller.

11. A system for a telecommunication network to provide a session service to Internet, wherein an access-side device of the telecommunication network supports an Internet application protocol, and the Internet is connected to the telecommunication network via an access gateway or an upgraded access-side device, wherein the telecommunication network is configured to provide a session service to an Internet user, and establish a session between the Internet user and a telecommunication user or another Internet user.

12. The system according to claim 11, wherein the Internet user establishes the session with the telecommunication user or the another Internet user through a Real-Time Communication in WEB-browsers (RTCWeb) technology, a Session Initiation Protocol (SIP) Plugin, or Hypertext Transfer Protocol (HTTP)/Simple Object Access protocol (SOAP)/Web2.0/HyperText Markup Language 5 (HTML5).

13. The system according to claim 11, wherein
the telecommunication network is connected to the Internet through an access gateway supporting an Internet protocol;
or the telecommunication network is connected to the Internet through enabling an access-side device to support an Internet protocol;
the Internet protocol comprises HTTP, or HTTP over Security Socket Layer (HTTPS), or Representational State Transfer (REST), or SIP Over HTTP or WebSocket;
the access gateway or the upgraded access-side device realizes conversion between HTTP and SIP.

14. The system according to claim 11, wherein
the telecommunication network is further configured to allocate a number or an identifier to the Internet user, wherein the allocated number or identifier is different from a user name in the Internet; or the telecommunication network is further configured to take a user name in an Internet application as the number or the identifier of the telecommunication network;
the Internet user registers with the telecommunication network and initiates a session request using the allocated number or identifier or the user name in the Internet application, and/or the Internet user accepts a session request to establish the session with the telecommunication user or the another Internet user.

15. The system according to claim 11, wherein
the telecommunication network associates a number or an identifier of the telecommunication network with a user name in an Internet function;
the telecommunication network calls an Internet user terminal or a telecommunication terminal preferentially through service control, or makes a forking call directed to the Internet user terminal and the telecommunication terminal.

16. The system according to claim 11, wherein the access-side device is a Session Border Controller (SBC) and a Proxy Call Session Control Function entity (P-CSCF); the Internet application protocol is HTTP/SOAP/Web2.0/HTML5.

17. The system according to claim 12, wherein the access-side device is a Session Border Controller (SBC) and a Proxy Call Session Control Function entity (P-CSCF); the Internet application protocol is HTTP/SOAP/Web2.0/HTML5.

18. The system according to claim 13, wherein the access-side device is a Session Border Controller (SBC) and a Proxy Call Session Control Function entity (P-CSCF); the Internet application protocol is HTTP/SOAP/Web2.0/HTML5.

19. The system according to claim 14, wherein the access-side device is a Session Border Controller (SBC) and a Proxy Call Session Control Function entity (P-CSCF);
the Internet application protocol is HTTP/SOAP/Web2.0/HTML5.

20. The system according to claim 15, wherein the access-side device is a Session Border Controller (SBC) and a Proxy Call Session Control Function entity (P-CSCF); the Internet application protocol is HTTP/SOAP/Web2.0/HTML5.
